(19) United States
(12) Patent Application Publication
(10) Pub. No.: US 2004/0018281 A1
(43) Pub. Date: Jan. 29, 2004

(54) Frozen, fully cooked fish and method of preparing same

(76) Inventor: Gregg Dowd, Bentonville, AR (US)

Correspondence Address: Mark Rogers, Speed & Rogers, P.A., Suite 125, 1701 Centerview, Little Rock, AR, 72211, US

(21) Appl. No.: 10/201,861

(22) Filed: Jul. 24, 2002

(51) Int. Cl. A23G 1/00

(52) U.S. Cl. 426/296

(57) ABSTRACT

The present invention involves the preparation of frozen, fully cooked, breaded, non-battered fish. A piece of fish is wetted with water and breaded with corn meal and seasoning. Batter is not applied to the fish. The breaded, non-battered fish is then fully cooked, frozen, and packaged. The fish is preferably cooked in peanut oil at a temperature of approximately 375° F. for approximately 3 minutes. During cooking, the fish may be moved from fryer to fryer to provide for faster cooking. After cooking, the fish is quickly frozen at low temperatures, such as by using a blast freezer, quick freezer, or spiral freezer. The frozen fish is then packaged.

### BACKGROUND OF THE INVENTION

This invention relates to a frozen fish product, and more particularly to a frozen, fully cooked fish product.

Frozen, fully cooked and similar fully cooked, ready to eat meat products have long been known. These items are gaining in popularity, largely because preparation times are short and advances have been made in their preparation so that the taste, texture, and appearance of many of these products have become more acceptable. Preparing frozen, fried fish that provides acceptable taste, texture, and appearance when it is reconstituted or re-cooked has presented special problems. It has been difficult to find a way to avoid problems caused by the cooking oil and caused by the interaction of the fish coating with oil and water when the fish is reconstituted or re-cooked.

Extensive effort has been devoted to developing a process for preparing frozen, fried fish that may be reconstituted. The most common solution to date has been to apply batter to the fish, possibly adding breading to the battered fish, and to par-fry or partially fry the fish before freezing and packaging it. The batters are typically thick, beaten or stirred liquids containing things such as milk or buttermilk, flour, shortening and eggs. In a typical par-fry process, the battered or battered and breaded fish is not fully cooked but is cooked only long enough to get the batter or batter and breading to adhere to the fish. Since the product is only partially cooked, it is not ready or safe to eat without further cooking, and reconstituting or re-cooking it takes an undesirably long time.

Frozen, fried fish is also typically by weight. When breaded, non-battered fish is fried, such as at home or at a restaurant, there is shrinkage that may range from approximately 10% to approximately 15% by weight. Using a batter helps to offset the shrinkage, so processors have a big incentive to continue using batter as they have in the past. Processors commonly use sufficient batter so that 1 pound of fish before cooking yields 1 pound after battering and cooking. Processors also commonly use different types of flour in their batters and breadings. The present inventor believes that it is undesirable to use batter and that it is undesirable to use flour for a number of reasons. For example, flour burns or scorches easily, batter and flour both tend to absorb too much oil during cooking, and batter and flour both tend to become soggy when reconstituted, particularly when they are reconstituted in a microwave.

The present inventor has been involved with a family catfish restaurant for years. In the family restaurants, fish is wetted, breaded with corn meal and seasonings, fried in peanut oil at approximately 375° F. for approximately 3 minutes, and served to the customer. When a batch of fish is placed in cooking oil, the temperature of that cooking oil typically decreases initially and then begins to return to the desired setting. For years, to reduce the time that the fish is left in oil, the inventor's restaurants have sometimes moved the fish from one fryer to an adjacent fryer during cooking, since the adjacent fryer will typically have peanut oil at approximately 375° F. instead of the reduced temperature present in the initial fryer. This cooks the fish faster and reduces the time the fish spends in the oil. Largely because of his interest in his family catfish restaurant business, the inventor also followed the development of ready to eat, fully cooked, frozen food products, and followed with particular interest the apparent inability of others to develop a fully cooked, frozen fish product that could be reconstituted in acceptable form. This inability of others to meet this long-felt need led the inventor to develop the fully cooked, frozen fried fish product of the present invention.

### SUMMARY OF THE INVENTION

It is therefore an object of the present invention to provide a frozen, fried fish product and a method of preparing the same that requires less time for a consumer to prepare.

It is a further object of the present invention to provide a frozen, fried fish product that has a superior taste, texture, and appearance when reconstituted.

It is a still further object of the present invention to provide a frozen, fully cooked fish product.

It is a still further object of the present invention to provide a frozen fish product that does not have a soggy, greasy coating when it is reconstituted.

It is a still further object of the present invention to provide a frozen fish product that offers superior results when it is reconstituted in the microwave.

It is a still further object of the present invention to provide a fully cooked, frozen, breaded, non-battered food item that has a superior taste, texture, and appearance when reconstituted.

Toward the fulfillment of these and other objects and advantages, the present invention involves the preparation of frozen, fully cooked, breaded, non-battered fish. A piece of fish is wetted with water and breaded with corn meal and seasoning. The breaded, non-battered fish is then fully cooked, frozen, and packaged. The fish is preferably cooked in peanut oil at a temperature of approximately 375° F. for approximately 3 minutes. During cooking, the fish may be moved from fryer to fryer to provide for faster cooking. After cooking, the fish is quickly frozen at low temperatures, such as by using a blast freezer, quick freezer, or spiral freezer. The frozen fish is then packaged.

### BRIEF DESCRIPTION OF THE DRAWINGS

The above brief description, as well as further objects, features and advantages of the present invention will be more fully appreciated by reference to the following detailed description of the presently preferred but nonetheless illustrative embodiments in accordance with the present invention when taken in conjunction with the accompanying drawings, wherein:

FIG. 1 is a flow diagram of the preferred embodiment of the present invention;

FIG. 2 is a flow diagram of an alternate embodiment of the present invention; and

FIG. 3 is a flow diagram of an alternate embodiment of the present invention.

### DETAILED DESCRIPTION OF THE PREFERRED EMBODIMENT

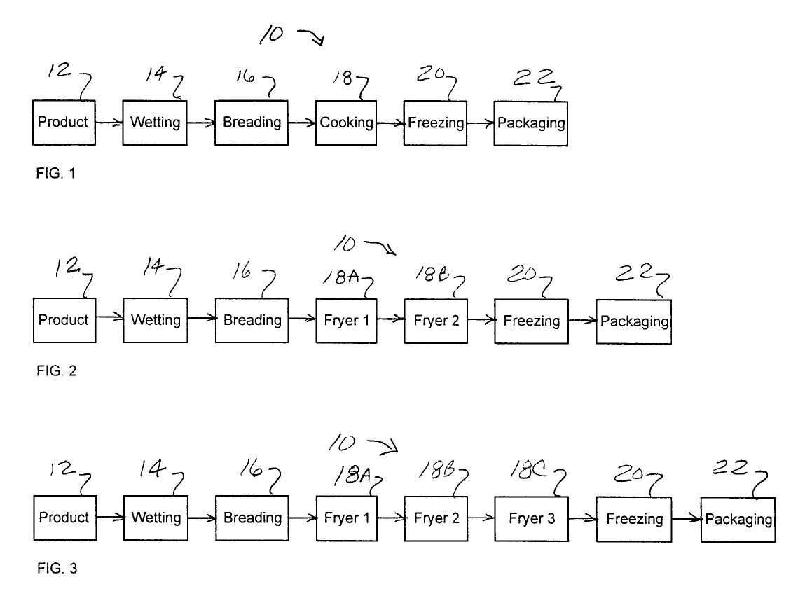

Referring to FIG. 1, the reference numeral 10 refers in general to a process of the present invention. As discussed in more detail below the product 12, such as a piece of fish, is wetted 14, breaded 16, cooked 18, frozen 20, and packaged 22.

The raw product 12 is a food to be fried, such as a meat, and more particularly fish. Filleted fish strips, particularly catfish strips, are preferred, but it is understood that any number of different types and forms of fish may be used. The raw product 12 may be fresh or frozen. If the fish is initially frozen, it is thawed or at least partially thawed. Although the process is described for use in connection with catfish strips, it is understood that it may be used in connection with a wide variety of foods, including but not limited to beef, poultry, fresh and salt water seafoods, fruits, vegetables, and dairy products.

The wetting process 14 is used to encourage the breading to adhere to the fish. Water is the preferred wetting agent. Wetting may be accomplished in any number of different ways. The fish may be dipped into the wetting agent, or the wetting agent may be sprayed or poured onto the fish. If the raw product 12 is frozen fish, the frozen fish may be submerged in water to thaw the fish and to accomplish the desired wetting. The wetting agent is typically water. Other wetting agents may be used, and other ingredients may be added to the water, but the wetting agent should not include flour or egg and should have a viscosity similar to that of water and not similar to that of a batter. The wetting 14 may be accomplished in batch mode or continuously and may be performed by hand or mechanically. For example, a person may manually submerge the fish in the water and remove the fish from the water. In an automated process, a breading machine may simply include a sprayer to wet the fish before it reaches the area of the breading machine in which the breading is applied.

After the fish is wetted 14, it is breaded 16. The breading is preferably comprised primarily of corn meal, but a variety of different breadings or mixes thereof may be used such as cracker meal, and other suitable meals, bread crumbs, and Japanese bread crumbs. It is preferred not to use flour, including but not limited to all purpose flour, wheat flour, white flour, corn flour, and the like because of the disadvantages of flour discussed above. The breading preferably includes one or more seasonings, including herbs and spices. The seasonings are preferably salt, pepper, and monosodium glutamate. It is of course understood that any of a wide variety of seasonings may be used, alone or in combination, including but not limited to salt, pepper, sugar, monosodium glutamate, cayenne, cilantro, basil, tarragon, fennel, cumin, paprika, parsley, thyme, nutmeg, ginger, rosemary, dill, chili powder, dry mustard, celery salt, garlic, caramel coloring, dextrose, scallions, allspice, and onion powder. As used herein, the term seasonings does not include buttermilk, milk, shortening, eggs, or batter.

The breading process 16 may be accomplished in batch mode or continuously and may be performed by hand or mechanically. For example, a person may manually place the fish in the breading and manipulate the fish to apply a proper coating of breading. In an automated process, a breading machine, such as a sprinkle breader may be used.

After breading 16, the breaded, non-battered fish is cooked 18, preferably by frying in a cooking oil, preferably peanut oil. As mentioned above, no batter is applied to the fish because of the problems associated with using batter as discussed above. The fish is preferably fully cooked but may be partially cooked or par-fried if desired. Before the fish is placed in the oil, the oil is heated to a temperature that is preferably substantially within a range of from approximately 350° F. to approximately 395° F., that is more preferably substantially within a range of from approximately 365° F. to approximately 385° F., and that is most preferably approximately 375° F. The fish is cooked in the oil for a time that is preferably approximately 2 minutes to approximately 4 minutes, that is more preferably approximately 2.5 minutes to approximately 3.5 minutes, and that is most preferably approximately 3 minutes.

The cooking process 18 may be accomplished in batch mode or continuously and may be performed by hand or mechanically. For example, a person may place a batch of the fish in a wire basket, lower the basket into the cooking oil, and remove the basket from the cooking oil after the desired time. In an automated process, a conveyor may carry the fish through a container of cooking oil with the length of the container and speed of the conveyor belt being selected to provide the desired cooking time.

FIGS. 2 and 3 depict alternate embodiments of the present invention in which the cooking portion 18A, 18B, and 18C is modified slightly. Particularly in a batch operation, when a large amount of fish is placed in a fryer, the temperature of the oil in the fryer typically drops, sometimes substantially. For example, when a three-pound batch of fish is placed in a standard restaurant or commercial fryer, the cooking oil in that fryer can quickly drop from approximately 375° F. to approximately 250° F. If the fish is left in that fryer 18A, the time needed to cook the fish is increased. Standard restaurant or commercial fryers often have adjacent, separate containers 18A, 18B, and 18C for holding separate amounts of cooking oil. Providing separate containers 18A, 18B, and 18C with separate amounts of cooking oil can be useful in a variety of applications. For example, a user may not want to fry different types of food in the same oil for fear that the flavor of one may be transferred to the other. According to the alternate embodiment of the present invention, the fish is cooked for a portion of the total cooking time in one container 1 8A, then moved for another portion of the cooking time to a different container 18B, 18C. If desired, any number of additional containers with separate amounts of cooking oil may be used. In the alternate embodiment depicted in FIG. 2, the fish is cooked in the first container 18A for a time that is preferably from approximately 30 seconds to approximately 150 seconds and that is more preferably approximately 90 seconds. The fish is then removed from the first container and promptly placed in the second container 18B without further processing other than maybe to shake or drain some of the oil from the fish. The fish is then cooked in the second container 18B for a time that is preferably from approximately 30 seconds to approximately 150 seconds and that is more preferably approximately 90 seconds. The total cooking time is preferably approximately 2 minutes to approximately 4 minutes, is more preferably approximately 2.5 minutes to approximately 3.5 minutes, and is most preferably approximately 3 minutes.

In the alternate embodiment depicted in FIG. 3, the fish is cooked in the first container 18A for a time that is preferably from approximately 30 seconds to approximately 90 seconds and that is more preferably approximately 60 seconds. The fish is then removed from the first container and promptly placed in the second container 18B without further processing other than maybe to shake or drain some of the oil from the fish. The fish is then cooked in the second container 18B for a time that is preferably from approximately 30 seconds to approximately 90 seconds and that is more preferably approximately 60 seconds. The fish is then removed from the second container and promptly placed in the third container 18C without further processing other than maybe to shake or drain some of the oil from the fish. The fish is then cooked in the third container 18C for a time that is preferably from approximately 30 seconds to approximately 90 seconds and that is more preferably approximately 60 seconds. The total cooking time is preferably approximately 2 minutes to approximately 4 minutes, is more preferably approximately 2.5 minutes to approximately 3.5 minutes, and is most preferably approximately 3 minutes. Cooking the fish in the manner depicted in FIGS. 2 and 3 provides for more control over the oil temperature and provides for decreased cooking time. This means that the fish will be in the oil for less time and that the fish and breading should absorb less oil.

After the fish is cooked, it is at least partially frozen 20. The cooked fish is moved into an environment or freezer, such as a blast freezer, quick freezer, or spiral freezer for rapidly freezing the cooked fish. The environment or freezer has a temperature that is preferably substantially within a range of from approximately 0° F. to approximately −70° F., and that is more preferably substantially within a range of from approximately −10° F. to approximately −50° F. The fish is left in the freezing environment for a time that is preferably substantially within a range of from approximately 20 minutes to approximately 4 hours and that is more preferably substantially within a range of from approximately 30 minutes to approximately 3 hours. The freezing process 20 may be accomplished in batch mode or continuously and may be performed by hand or mechanically. For example, a person may remove the cooked fish from the oil, drain it, such as by shaking the wire basket holding the fish, and place it on a pan or tray. When the desired amount of fish is cooked or accumulated, the user may move the pan or tray, or a rack of pans or trays, into a freezer for the desired amount of time. In an automated process, a conveyor line may move the fish from the fryer section to a freezer section, and the belt speed within the freezer may be controlled to achieve the desired residence time in the freezer.

After the fish is at least partially frozen, it is packaged 22 for storage, transport, or resale. The frozen or partially frozen fish is placed in a package, such as a bag or box, and is weighed. It is understood that a wide variety of packaging may be used. It is also understood that the cooked fish could be packaged before freezing, but there are disadvantages to doing so. The cooked, unfrozen fish is relatively fragile and is more prone to tearing, ripping, and losing breading. It is much easier to handle the fish without damaging it after it has been at least partially frozen. The packaging process 22 may be accomplished in batch mode or continuously and may be performed by hand or mechanically.

Other modifications, changes and substitutions are intended in the foregoing, and in some instances, some features of the invention will be employed without a corresponding use of other features. For example, although it is preferred to fully cook the fish, it is understood that the fish may be partially cook or par-fried before being frozen. Similarly, although it is preferred to completely freeze the cooked fish before placing it in packaging, it is understood that the cooked fish may be placed in packaging without being frozen or after the cooked fish has been only partially frozen. Although the above description has focused on fish, and more particularly on catfish strips, it is understood that the process may be useful for frying any food to be frozen. Of course, quantitative information is included by way of example only and is not intended as a limitation as to the scope of the invention. Accordingly, it is appropriate that the invention be construed broadly and in a manner consistent with the scope of the invention disclosed.

What is claimed is:

1. A method, comprising:
(1) wetting a piece of meat;
(2) applying corn meal to said wetted piece to prepare a breaded, non-battered piece;
(3) at least partially cooking said breaded, non-battered piece;
(4) after step (3), at least partially freezing said breaded, non-battered piece; and
(5) after step (4), placing said breaded, non-battered piece in a package.

2. The method of claim 1, wherein said piece of meat comprises fish.

3. The method of claim 1, wherein step (3) comprises fully cooking said breaded, non-battered piece.

4. The method of claim 3, wherein said step of fully cooking said breaded, non-battered piece comprises:
(1) providing cooking oil having a temperature substantially within a range of from approximately 350° F. to approximately 395° F.; and
(2) placing said breaded, non-battered piece in said cooking oil for a time of from approximately 2 minutes to approximately 4 minutes.

5. The method of claim 3, wherein said step of fully cooking said breaded, non-battered piece comprises:
(1) providing first and second containers having separate first and second amounts of cooking oil;
(2) placing said breaded, non-battered piece in said first amount of cooking oil for a time of from approximately 30 seconds to approximately 150 seconds, said first amount of cooking oil having a first temperature that is substantially within a range of from approximately 250° F. to approximately 395° F. before said breaded, non-battered piece is placed in said first amount of cooking oil;
(3) after step (2), removing said breaded, non-battered piece from said first amount of cooking oil and placing said breaded, non-battered piece in said second amount of cooking oil for a time of from approximately 30 seconds to approximately 150 seconds, said second amount of cooking oil having a second temperature that is substantially within a range of from approximately 300° F. to approximately 395° F. before said breaded, non-battered piece is placed in said second amount of cooking oil.

6. The method of claim 3, wherein said step of fully cooking said breaded, non-battered piece comprises:
(1) providing first, second, and third containers having separate first, second, and third amounts of cooking oil;
(2) placing said breaded, non-battered piece in said first amount of cooking oil for a time of from approximately 30 seconds to approximately 90 seconds, said first amount of cooking oil having a first temperature that is substantially within a range of from approximately 250° F. to approximately 395° F. before said breaded, non-battered piece is placed in said first amount of cooking oil;
(3) after step (2), removing said breaded, non-battered piece from said first amount of cooking oil and placing said breaded, non-battered piece in said second amount of cooking oil for a time of from approximately 30 seconds to approximately 90 seconds, said second amount of cooking oil having a second temperature that is substantially within a range of from approximately 300° F. to approximately 395° F. before said breaded, non-battered piece is placed in said second amount of cooking oil;
(5) after step (3), removing said breaded, non-battered piece from said second amount of cooking oil and placing said breaded, non-battered piece in said third amount of cooking oil for a time of from approximately 30 seconds to approximately 90 seconds, said third amount of cooking oil having a third temperature that is substantially within a range of from approximately 320° F. to approximately 395° F. before said breaded, non-battered piece is placed in said third amount of cooking oil.

7. The method of claim 1, wherein step (3) comprises placing said breaded, non-battered piece in cooking oil for a time of from approximately 2 minutes to approximately 4 minutes, said cooking oil having a temperature substantially within a range of from approximately 350° F. to approximately 395° F. before said breaded, non-battered piece is placed in said cooking oil.

8. The method of claim 1, wherein step (3) comprises placing said breaded, non-battered piece in peanut oil for a time of from approximately 2.5 minutes to approximately 3.5 minutes, said peanut oil having a temperature substantially within a range of from approximately 370° F. to approximately 380° F. before said breaded, non-battered piece is placed in said peanut oil.

9. The method of claim 1, wherein step (4) comprises:
after step (3), placing said breaded, non-battered piece in an environment having a temperature that is substantially within a range of from approximately 0° F. to approximately −70° F. for a time of from approximately 20 minutes to approximately 4 hours.

10. The method of claim 1, wherein step (4) comprises:
after step (3), placing said breaded, non-battered piece in a blast freezer, quick freezer, or spiral freezer having a temperature that is at or below −10° F.

11. A packaged, frozen piece of fish prepared by the following process:
(1) wetting a piece of fish;
(2) applying a breading to said wetted piece to prepare a breaded, non-battered piece;
(3) at least partially cooking said breaded, non-battered piece;
(4) after step (3), at least partially freezing said breaded, non-battered piece; and
(5) after step (4), placing said breaded, non-battered piece in a package.

12. The packaged, frozen piece of fish prepared by the process of claim 11, wherein said breading comprises corn meal.

13. The packaged, frozen piece of fish prepared by the process of claim 11, wherein said breading consists essentially of corn meal and one or more seasonings.

14. The packaged, frozen piece of fish prepared by the process of claim 13, wherein said one or more seasonings are selected from the group consisting of salt, pepper, sugar, monosodium glutamate, cayenne pepper, cilantro, basil, tarragon, fennel, cumin, paprika, parsley, thyme, nutmeg, ginger, rosemary, dill, chili powder, dry mustard, celery salt, garlic, caramel coloring, dextrose, scallions, allspice, and onion powder.

15. The packaged, frozen piece of fish prepared by the process of claim 11, wherein step (3) comprises fully cooking said breaded, non-battered piece.

16. The packaged, frozen piece of fish prepared by the process of claim 11, wherein step (3) comprises placing said breaded, non-battered piece in cooking oil for a time of from approximately 2 minutes to approximately 4 minutes, said cooking oil having a temperature that is substantially within a range of from approximately 350° F. to approximately 395° F. before said breaded, non-battered piece is placed in said cooking oil.

17. The packaged, frozen piece of fish prepared by the process of claim 11, wherein step (3) comprises:
(1) providing first and second containers having first and second amounts of cooking oil, said first and second amounts of said cooking oil having a temperature substantially within a range of from approximately 350° F. to approximately 395° F.;
(2) placing said breaded, non-battered piece in said first amount of cooking oil for a time of from approximately 30 seconds to approximately 150 seconds;
(3) removing said breaded, non-battered piece from said first amount of cooking oil and placing said breaded, non-battered piece in said second amount of cooking oil for a time of from approximately 30 seconds to approximately 150 seconds.

18. A method, comprising:
(1) providing a food item, said food item consisting essentially of:
a piece of fish;
corn meal applied to said piece of fish; and
one or more seasonings applied to said piece of fish;
(2) at least partially cooking said food item;
(3) at least partially freezing said fully cooked food item; and
(4) after step (3), placing said food item in a package.

19. The method of claim 18, wherein said one or more seasonings are selected from the group consisting of salt, pepper, sugar, monosodium glutamate, cayenne pepper, cilantro, basil, tarragon, fennel, cumin, paprika, parsley, thyme, nutmeg, ginger, rosemary, dill, chili powder, dry mustard, celery salt, garlic, caramel coloring, dextrose, scallions, allspice, and onion powder.

20. The method of claim 16, wherein step (2) comprises placing said food item in cooking oil for a time of from approximately 2 minutes to approximately 4 minutes, said cooking oil having a temperature that is substantially within a range of from approximately 350° F. to approximately 395° F. before said food item is placed in said cooking oil.
